(19) United States
(12) Patent Application Publication
(10) Pub. No.: US 2002/0059295 A1
(43) Pub. Date: May 16, 2002

(54) METHOD AND SYSTEM FOR DISTRIBUTED QUEUES IN A MULTIMEDIA NETWORK

(76) Inventors: HAROLD AARON LUDTKE, SAN JOSE, CA (US); MICHAEL W. BLASGEN, LOS GATOS, CA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/239,696

(22) Filed: Jan. 29, 1999

(51) Int. Cl. G06F 7/00

(52) U.S. Cl. 707/104.1

(57) ABSTRACT

Methods and systems consistent with the present invention queue a plurality of requests without the associated data. Servicing devices in a multimedia network, for example an audio/video (AV) network, receive requests without the associated data from one or more requesting devices in the AV network, and store the requests in a plurality of queues. When a servicing device is ready to perform a service associated with a stored request, the servicing device retrieves the associated data from a requesting device or other devices that provide the associated data. When performing the service, the servicing device may generate one or more results, which the servicing device sends to the requesting device or other devices in the AV network. After performing the service, the servicing device removes the stored request from the queue.

### CROSS-REFERENCE TO RELATED APPLICATIONS

This application is related to U.S. application Ser. No. ______, entitled “Method And System For Distributed Queues In A Multimedia Network With Proxies,” Attorney Docket No. 07095.0025-00000, and filed concurrently herewith.

### TECHNICAL FIELD

The present invention relates generally to multimedia networks, and more particularly, to a method and system for distributed queues in a multimedia network.

### BACKGROUND OF THE ART

With advancements in digital bus technologies, a variety of consumer electronic and computing devices can be integrated to form a multimedia network, for example, an audio/video (AV) network. One such bus standard is the Institute of Electrical and Electronics Engineers 1394 (IEEE 1394) digital interface standard, which enables high speed data communication between consumer electronic devices such as, video camcorders, electronic still cameras, computers, and digital audio and video equipment.

Furthermore, higher layer communication protocols, such as International Electrotechnical Commission 61883 (IEC 61883), Audio Video Control (AV/C), and Home Audio/Video interoperability (HAVi) standards, allow complex communication between consumer electronic devices. By taking advantage of these higher layer protocols and the IEEE 1394 bus standard, consumer electronic devices are becoming more integrated.

As these devices become integrated and perform more complex tasks, sharing of data between the devices becomes more important. Some devices in an AV network may perform data “capturing” services, such as capturing digital still images, while other devices may perform specialized data “processing” services, such as printing or displaying the captured images. To integrate the data capturing with the data processing services, however, the devices in the AV network must somehow share the captured data.

As an illustration, consider an AV network that includes an IEEE 1394 bus connecting a plurality of video cameras to a printer. Each video camera in the AV network performs a data capturing service when the video camera captures still digital images. The printer, on the other hand, performs a data processing service when the printer prints the captured still images. To print the captured images, each video camera sends to the printer one or more requests, which may include one or more associated images. Since each request may include several associated images, and the printer may receive concurrent requests from a number of video cameras, the printer must have sufficient storage or memory resources to receive and store the requests and their associated images.

Most consumer electronic devices, however, have insufficient storage or memory resources to process such requests from a plurality of devices in an AV network because of the significant amount of data associated with the requests. Therefore, it is desirable to have a method and system for performing services in a multimedia network that overcome the above and other disadvantages of the prior art.

### DISCLOSURE OF THE INVENTION

Methods and systems consistent with the present invention perform services in a multimedia network by queuing in servicing devices a plurality of requests without the associated data and retrieving the associated data from one or more requesting devices when a servicing device is ready to perform a service associated with a queued request. The data associated with a request may include any type of digitized information, for example, text, audio, video, and graphics.

Requesting and servicing devices may include any consumer electronics or computing devices, for example digital video cameras, personal computers (PCs), digital video monitors, audio actuators, and video actuators that include a serial interface, which complies with a serial interface standard for networking consumer electronic devices, for example, IEEE 1394 standard.

A service is broadly defined herein to include any processing performed by a servicing device using the associated data, for example, printing the associated data, displaying the associated data on a digital monitor, adding sound effects to the associated data, or adding visual effects or animation to the associated data, etc.

In accordance with an embodiment of the invention, a servicing device receives via a serial interface a first request from a first requesting device to perform a service, for example to print one or more digitally captured images, and stores the received first request in a queue at the servicing device. When the first requesting device provides the data associated with the stored first request (e.g., the digitally captured images) and the servicing device is ready to perform the service associated with the stored first request, the servicing device retrieves the associated data from the first requesting device.

When the first requesting device does not provide the associated data and instead a second requesting device in the multimedia network provides the associated data, the first requesting device notifies the second requesting device as to the stored first request, the associated data, and the servicing device. When the servicing device is ready to perform the service, the servicing device retrieves the associated data from the second requesting device.

When performing the service, the servicing device may generate one or more results, which the servicing device sends to the requesting device or other devices in the network. After performing the service, the servicing device removes the stored first request from the queue.

Methods and systems consistent with the present invention have several advantages over the prior art. First, servicing devices in multimedia networks can process requests from a plurality of requesting devices without requiring expensive memory and storage resources in each servicing device. Second, requesting devices can perform other tasks while their respective requests are pending in servicing devices, thereby maximizing the resources available on each individual requesting device.

The description of the invention and the following description for carrying out the best mode of the invention should not restrict the scope of the claimed invention. Both provide examples and explanations to enable others to practice the invention. The accompanying drawings, which form part of the description for carrying out the best mode of the invention, show several embodiments of the invention, and together with the description, explain the principles of the invention.

### BRIEF DESCRIPTION OF THE DRAWINGS

In the Figures:

FIG. 1 is a block diagram of a multimedia network, in accordance with an embodiment of the present invention;

FIG. 2 is a block diagram of a requesting device, in accordance with an embodiment of the present invention;

FIG. 3 is a block diagram of a servicing device, in accordance with an embodiment of the present invention;

FIG. 4 is a flow chart of a process performed by a requesting program in a requesting device, in accordance with an embodiment of the present invention; and

FIG. 5 is a flow chart of a process performed by a servicing program in a servicing device, in accordance with an embodiment of the present invention.

### BEST MODE FOR CARRYING OUT THE INVENTION

Reference will now be made in detail to the preferred embodiments of the invention, examples of which are illustrated in the accompanying drawings. Wherever possible, the same reference numbers will be used throughout the drawings to refer to the same or like parts.

In accordance with methods and systems consistent with the present invention, servicing devices in a multimedia network, for example an audio/video (AV) network, queue a plurality of requests without the associated data. Servicing devices receive the requests via a serial interface from one or more requesting devices in the network and store the requests in a plurality of queues.

When a servicing device is ready to perform a service, for example printing one or more digitally captured images, associated with a request stored in a queue, the servicing device retrieves the associated data (e.g., the captured images) from one or more requesting devices that provide the associated data.

When performing the service, the servicing device may generate one or more results, which the servicing device sends to the requesting device or other devices in the AV network. After performing the service, the servicing device removes the stored first request from the queue.

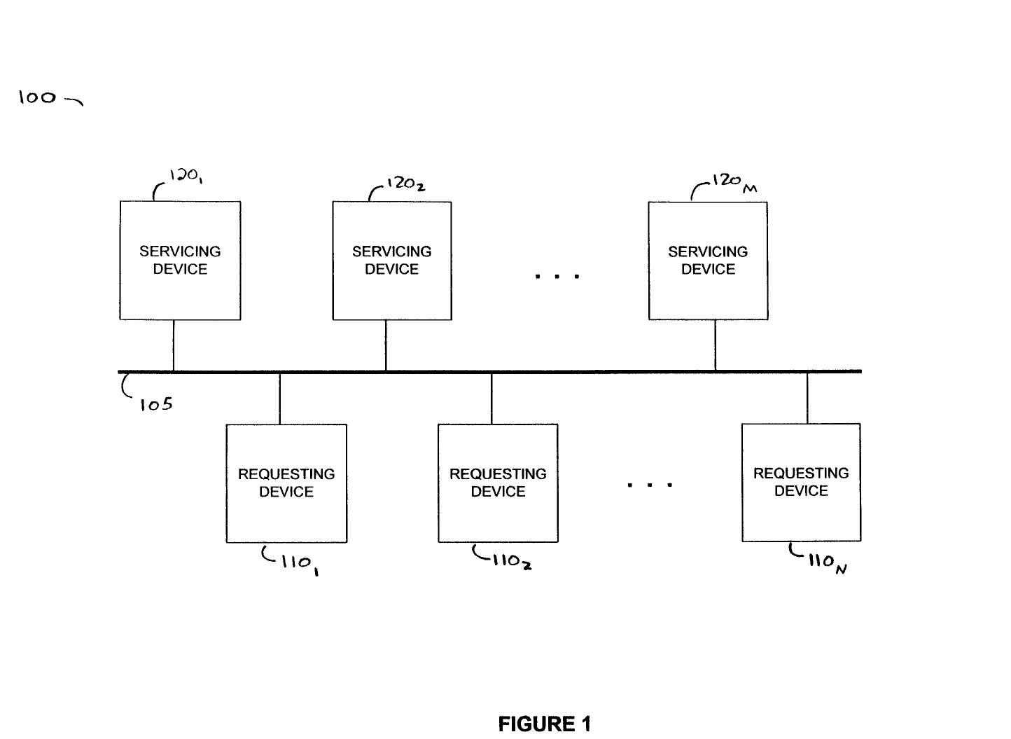

FIG. 1 is a block diagram of a multimedia network 100, in accordance with an embodiment of the present invention. In one embodiment, multimedia network 100 comprises an IEEE 1394 bus 105, which interconnects N requesting devices 110₁-110_{N} and M servicing devices 120₁-120_{M}. Alternatively, in another embodiment, multimedia network 100 may comprise a wireless serial interface for enabling communication between requesting devices 110₁-110_{N} and servicing devices 120₁-120_{M}.

In the embodiment of FIG. 1, bus 105 may, for example, be a high speed serial bus, which enables communication between requesting devices 110₁-110_{N} and servicing devices 120₁-120ₘ at speeds of 1 Mbits/sec or greater, for example, 10, 100, or 400 Mbits/sec. Alternatively, bus 105 may, for example, be a low speed serial bus, which enables communication between requesting devices 110₁-110_{N} and servicing devices 120₁-120_{M} at speeds of less than 1 Mbit/sec, for example, 1, 10, or 100 Kbits/sec.

Requesting devices 110₁-110_{N} may each include, for example, a digital video camera, digital video cassette recorder (VCR), digital still image camera, personal computer (PC), or any other consumer electronics device that includes a serial interface, which complies with a serial standard for networking consumer electronic devices, for example, IEEE 1394 standard.

Servicing devices 120₁-120_{M} may each include, for example, a printer, digital monitor, digital speakers, PC, audio actuator, video actuator, or any other consumer electronics device that includes a serial interface, which complies with a serial interface standard for networking consumer electronic devices, for example, IEEE 1394 standard.

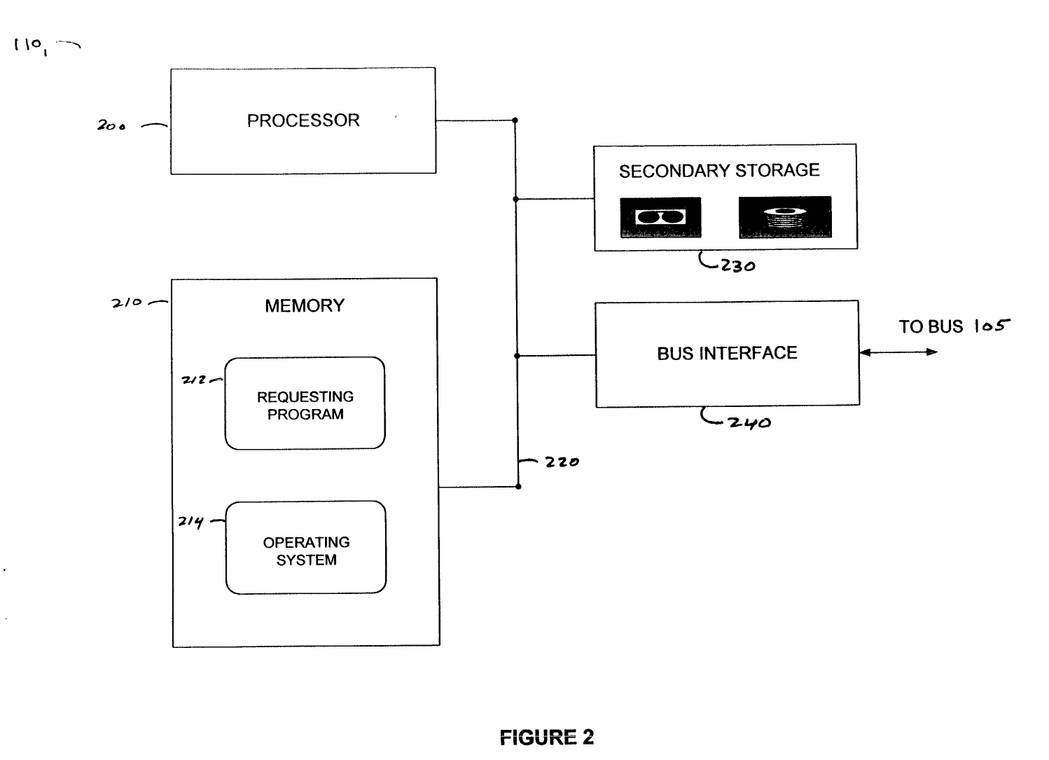

FIG. 2 is a block diagram of a requesting device, for example requesting device 110₁, in accordance with an embodiment of the invention. Requesting device 110₁ comprises a processor 200, which connects via a bus 220 to a memory 210, a secondary storage 230, and a bus interface unit 240.

Memory 210 comprises a requesting program 212 and an operating system 214, each of which includes instructions in the form of software or firmware executed by processor 200.

Secondary storage 230 may include, for example, a hard disk drive, a digital versatile disc (DVD), compact disc-read only memory (CD-ROM), or a video cassette.

Bus interface unit 240, which connects to bus 105, may comprise hardware and software or firmware for sending and receiving data on bus 105 using, for example, International Electrotechnical Commission 61883 (IEC 61883), Audio Video Control (AV/C), and/or Home Audio/Video interoperability (HAVi) protocols.

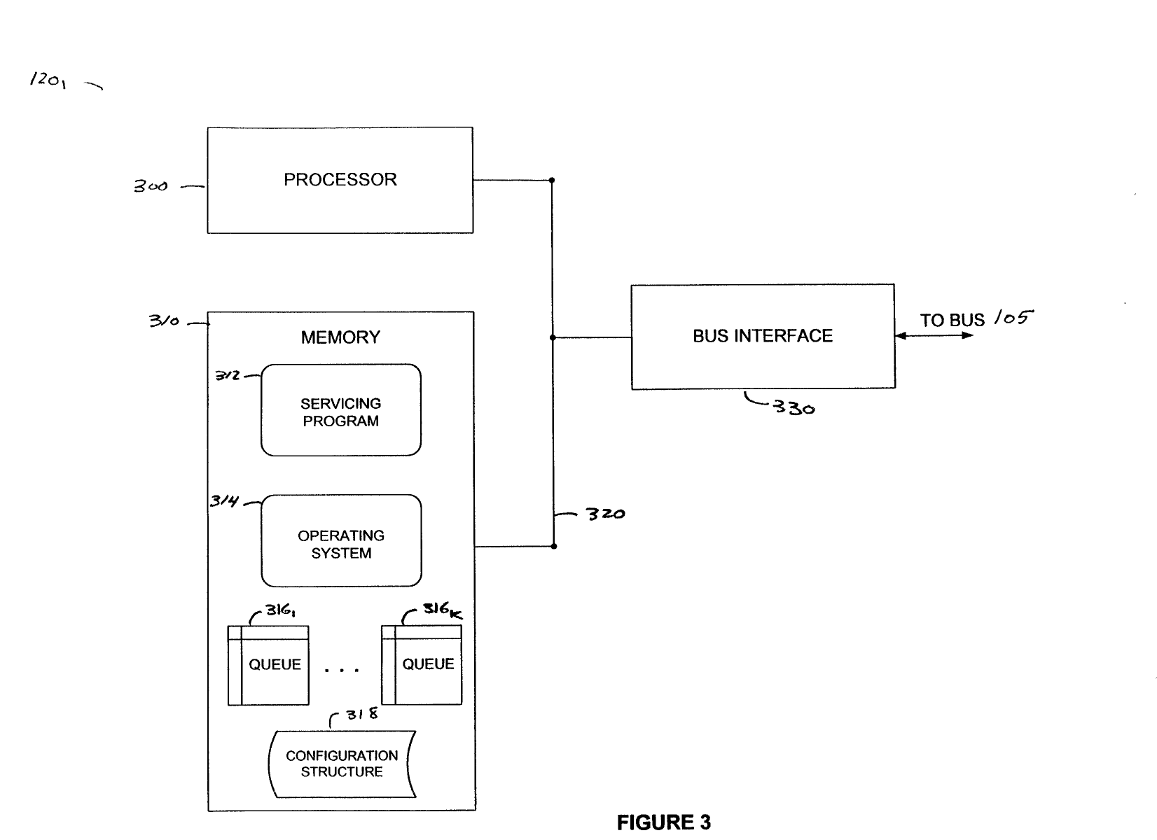

FIG. 3 is a block diagram of a servicing device, for example servicing device 120₁, in accordance with an embodiment of the present invention. Servicing device 120₁ comprises a processor 300, which connects via a bus 320 to a memory 310, and a bus interface unit 330.

Memory 310 comprises a servicing program 312, an operating system 314, K queues 316₁-316_{K}, where K is an integer greater than or equal to 1, and a configuration structure 318. Servicing program 312 and operating system 314 include instructions in the form of software or firmware, which processor 300 executes.

Servicing program 312 stores the requests received from requesting devices 110₁-110_{N} in queues 316₁-316_{K}. Each queue 316₁-316_{K} may, for example, be implemented as a linked list or an array of request structures, where each request structure is associated with a particular request. Each queue 316₁-316_{K} includes an associated status structure, which includes, for example, real-time information about the queue and the request that is currently served by servicing program 312.

Configuration structure 318 may include, for example, the number of queues 316₁-316_{K} in servicing device 120₁, the maximum number of requests that can be queued in servicing device 120₁, and whether requesting devices 110₁-110_{N} can dynamically modify the priority of requests in queues 316₁-316_{K}. Configuration structure 318 may be pre-configured by, for example, the manufacturer of servicing device 120₁.

Bus interface unit 330, which connects to bus 105, may comprise hardware and software or firmware for sending and receiving data on bus 105 using, for example, IEC 61883, AV/C, and/or HAVi protocols.

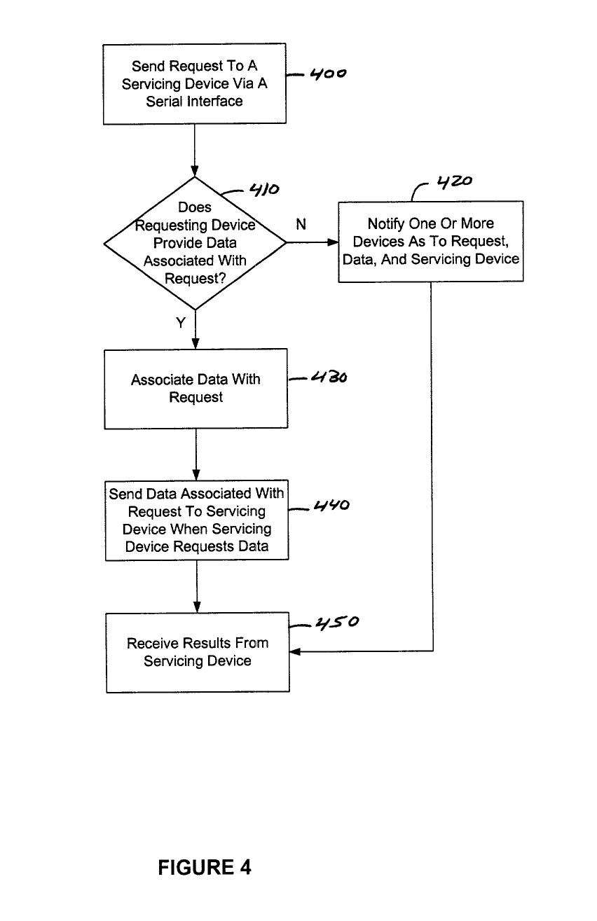

FIG. 4 is a flow chart of the process performed by requesting program 212 in requesting device 110₁, in accordance with an embodiment of the present invention. Receiving program 212 sends a request without the associated data items to a servicing device, for example servicing device 120₁, to perform a service (stage 400). The associated data items may include any type of digitized information, for example, text, audio, video, and graphics. The requested service may include, for example, printing the data items, adding sound effects to the data items, or adding visual effects or animation to the data items, etc.

Receiving program 212 may send to servicing device 120₁ a Post Request command, which includes as its input parameters a request descriptor, a request identifier, and a request parameter and as its output parameter a queue identifier. The request descriptor may identify a particular service, for example printing one or more data items, which is to be performed by servicing device 120₁. The request identifier may include, for example, an alphanumeric string, which uniquely identifies the request.

The request parameter may be a structure, which includes the global unique identifiers associated with requesting devices 110₁-110_{N} that provide the data items associated with the request, the global unique identifiers associated with requesting devices 110₁-110_{N} to which servicing device 120₁ must send one or more results associated with the service, the number of associated data items, and a priority assigned by requesting program 212. In addition, the request parameter may also include a description of the request in, for example, ASCII format.

In response to the Post Request command, the servicing device 120₁ returns to requesting device 110₁ the output parameter queue identifier, which uniquely identifies in servicing device 120₁ one of the queues 316₁-316_{K}, for example queue 316₁, that stores the request.

Requesting program 212 then determines whether requesting device 110₁ provides the data items associated with the request (stage 410). Requesting device 110₁ may, for example, include the associated data items or retrieve the associated data items from other devices in multimedia network 100 or from a user.

If requesting device 110₁ does not provide the associated data items, requesting program 212 identifies one or more of the requesting devices 110₂-110_{N} that provide the associated data items, and notifies the identified requesting devices 110₂-110_{N} as to the request identifier, the associated data items, and the global unique identifier of servicing device 120₁ (stage 420).

For example, requesting program 212 may send to each identified requesting device 110₂-110_{N} a Prepare Data command, which includes as its input parameters the request identifier, associated data item identifiers, and the global unique identifier of servicing device 120₁. The identified requesting devices 110₂-110_{N} then prepare to send servicing device 120₁ the associated data items when servicing device 120₁ requests the data items.

If requesting device 110₁ provides the associated data items, requesting program 212 associates the data items with the request identifier (stage 430). When servicing device 120₁ requests the associated data item from requesting device 110₁, requesting program 212 sends the associated data items to servicing device 120₁ (step 440). After servicing device 120₁ performs the service associated with the request, requesting program 212 receives one or more results associated with the request from servicing device 120₁ (step 450).

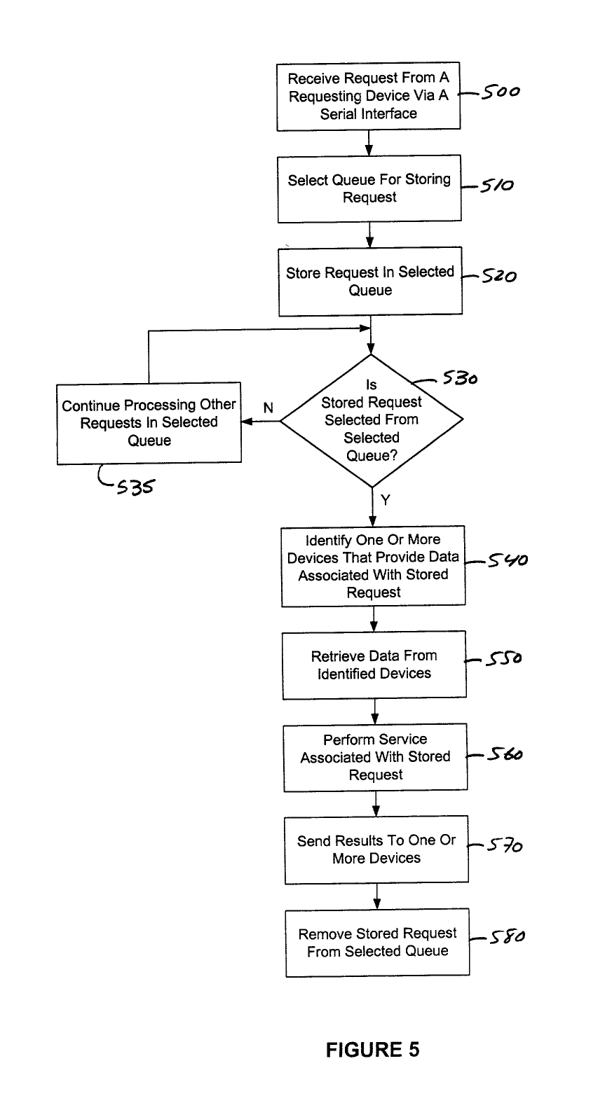

FIG. 5 is a flow chart of the process performed by servicing program 312 in servicing device 120₁, in accordance with an embodiment of the invention. Servicing device 120₁ receives a request, for example a Post Request command, from requesting device 110₁ (stage 500). The request descriptor in the Post Request command identifies a particular service, for example printing one or more data items, adding sound effects to the data items, or adding visual effects or animation to the data items, which servicing device 120₁ must perform.

Servicing program 312 selects one of the queues 316₁-316_{K}, for example, queue 316₁ (stage 510) and returns to requesting device 110₁ the queue identifier associated with queue 316₁. Servicing program 312 then stores the received request in the selected queue 316₁ (stage 520). For example, servicing program 312 creates a request structure, and stores the request structure in the selected queue 316₁. If servicing program 312 uses, for example, a first-in-first-out (FIFO) method for serving requests that are stored in queues 316₁-316_{K}, servicing program 312 stores the request at the end of the selected queue 316₁.

Servicing program 312 may include in the request structure, for example, the request identifier associated with the request, the request descriptor, the global unique identifier of requesting device 110₁, the global unique identifier of requesting devices 110₁-110_{N} that provide the data items associated with the request, and the global unique identifier of requesting devices 110₁-110_{N} to which servicing program 312 must send one or more results associated with the service. In addition, servicing program 312 may also include in the request structure the number of data items and the priority associated with the request.

Servicing program 312 then determines if there are other requests in the selected queue 316₁ that must be served before the stored request (stage 530). If servicing program 312 determines that there are other requests that must be served before the stored request, servicing program 312 continues to sequentially serve the other requests (stage 535).

If servicing program 312 selects the stored request, servicing program 312 updates the status structure associated with the selected queue 316₁. Servicing program 312 may update the status structure to include, for example, the request identifier associated with the selected request, the number of associated data items, a data item identifier associated with the associated data item currently being processed by servicing program 312, the number of bytes of the current data item processed, the global unique identifier associated with requesting device 110₁, the global unique identifiers associated with the requesting devices 110₁-110_{N} that provide the associated data items, and the global unique identifiers associated with the requesting devices 110₁-110_{N} to which servicing device 120₁ must send the results associated with the selected request. In addition, servicing program 312 may update the status structure to also include a description of the selected request in, for example, ASCII format, which may be displayed to a user.

Servicing program 312 then identifies the requesting devices 110₁-110_{N} that provide the associated data items (stage 540), and retrieves the associated data items from the identified requesting devices 110₁-110_{N} (stage 550).

For example, servicing program 312 may send to each identified requesting device 110₁-110_{N} a Fetch Request Data command, which includes as its input parameters the global unique identifier associated with requesting device 110₁, the request identifier associated with the selected request, and a connection identifier. In response to the Fetch Request Data command, each identified requesting device 110₁-110_{N} establishes, for example, an asynchronous or isochronous connection with servicing device 120₁, and sends the associated data items stored therein to servicing device 120₁.

Servicing program 312 then performs the service associated with the selected request, for example prints the associated data items, adds sound effects to the associated data items, or adds visual effects or animation to the data items, etc.(step 560). When performing the service, servicing program 312 may generate one or more results associated with the service, which servicing program 312 sends to one or more requesting devices 110₁-110_{N} identified in the request structure (step 570). The results may include, for example, new data generated by servicing program 312 (e.g. audio and visual effects), the associated data items that are modified by servicing program 312, and return codes, which indicate whether servicing program 312 successfully performed the service.

To send the associated results to the identified requesting devices 110₁-110_{N}, servicing program 312 may send to each identified requesting device 110₁-110_{N} a Receive Request Data command, which includes as its input parameters the global unique identifier associated with requesting device 110₁, the request identifier associated with the selected request, and a connection identifier. In response to the Receive Request Data command, each identified requesting device 110₁-110_{N} establishes, for example, an asynchronous or isochronous connection with servicing device 120₁, and prepares to receive the associated results from servicing device 120₁. Servicing program 312 then sends the associated results to the identified requesting devices 110₁-110_{N}.

When the connection between servicing device 120₁ and an identified requesting device 110₁-110_{N} is asynchronous, the connection identifier may identify, for example, an asynchronous connection plug associated with servicing device 120₁. Alternatively, when the connection is isochronous, the connection identifier may identify, for example, an isochronous channel allocated by servicing program 312.

In the case of an asynchronous connection, after an identified requesting device 110₁-110_{N} sends the associated data items in response to a Fetch Data Request command, the identified requesting device 110₁-110_{N} includes in its last data transfer, for example, an end-of-frame indicator to signal the end of the data transfer.

In the case of an isochronous connection, after an identified requesting device 110₁-110_{N} sends the associated data items in response to a Fetch Data Request command, the identified requesting device 110₁-110_{N} sends, for example, an End Of Request command to servicing device 120₁ to signal the end of the data transfer. The End Of Request command includes as its input parameters, for example, the queue identifier associated with queue 316₁ and the request identifier associated with the request.

After sending the associated results, servicing program 312 removes the selected request from the selected queue 316₁ (stage 580).

In accordance with another embodiment, requesting program 212 may query servicing device 120₁ about one or more of queues 316₁-316_{K}. For example, requesting program 212 may send to servicing device 120₁ a Count Queues command, which includes as its output parameters a list of queue identifiers associated with queues that are active and the number of queues in servicing device 120₁.

When servicing device 120₁ receives the Count Queues command, servicing program 312 identifies the queue identifiers associated with queues 316₁-316_{K} that are active, and using configuration structure 318, determines the number of queues 316₁-316_{K}. Based on the identified queue identifiers and the determined number of queues 316₁-316_{K}, servicing program 312 updates the output parameters in Count Queues command, and returns the updated output parameters to requesting device 110₁.

Requesting program 212 may also request servicing device 120₁ to notify requesting device 110₁ when the status of a queue, for example queue 316₁, in servicing device 120₁ changes. For example, requesting program 212 may send to servicing device 120₁ a Notify Queue Change command, which includes as its input parameter a queue identifier associated with queue 316₁. A change in the status of queue 316₁ may be defined, for example, as a transition from an empty state to a full state or from an active state to an inactive state.

In response to the Notify Queue Change command, when servicing program 312 detects a change in the status of queue 316₁, servicing program 312 sends to requesting device 110₁, for example, a Queue Has Changed command, which includes as its output parameter the queue identifier associated with queue 316₁.

Requesting program 212 may also query the contents of queues 316₁-316_{K}. For example, requesting program 212 may send to servicing device 120₁ a Read Request Queue, which includes as its input parameters the queue identifier associated with queue 316₁ and a connection identifier.

When servicing device 120₁ receives the Read Request Queue command, servicing program 312 establishes, for example, an asynchronous connection with requesting device 110₁, and sends to requesting device 110₁ the request structure information associated with each request stored in queue 316₁. After sending the request structure information, servicing program 312 terminates the asynchronous connection. Alternatively, servicing program 312 may keep the connection open to process, for example, the next request in queue 316₁.

Alternatively, the Read Request Queue may include as its output parameter a queue structure, which includes the entire contents of queue 316₁. In this case, when servicing device 120₁ receives the Read Request Queue command, servicing program 312 may copy the entire contents of queue 316₁ into the queue structure, and return the queue structure to requesting device 110₁.

Requesting program 212 may also remove a request from queue 316₁. For example, requesting program 212 may send to servicing device 120₁ a Remove Request command, which includes as its input parameters the queue identifier associated with queue 316₁ and the request identifier associated with the request. When servicing device 120₁ receives the Remove Request command, servicing program 312 removes from queue 316₁ the request structure associated with the request identifier.

Requesting program 212 may also set the priority of a request in queue 316₁. For example, requesting program 212 may send to servicing device 120₁ a Set Request Priority command, which includes as its input parameters the queue identifier associated with queue 316₁, the request identifier associated with the request, and the desired priority. When servicing device 120₁ receives the Set Request Priority command, servicing program 312 modifies the priority in the request structure associated with the request identifier. Servicing program 312 then modifies the order of the request in queue 316₁ according to the modified priority.

Requesting program 212 may also suspend a request in queue 316₁. For example, requesting program 212 may send to servicing device 120₁ a Suspend Request command, which includes as its input parameters the queue identifier associated with queue 316₁ and the request identifier associated with the request. When servicing device 120₁ receives the Suspend Request command, servicing program 312 suspends the request until servicing device 120₁ receives, for example, a Resume Request command from requesting device 110₁.

The Resume Request command may include as its input parameters, for example, the queue identifier associated with queue 316₁ and the request identifier associated with the request. When servicing device 120₁ receives the Resume Request command, servicing program 312 reactivates the suspended request.

Requesting program 212 may also query the status of queues 316₁-316_{K}, for example queue 316₁. For example, requesting program 212 may send to servicing device 120₁ a Read Status Structure command, which includes as its input parameters the queue identifier associated with queue 316₁ and a connection identifier. Servicing program 312 then establishes a connection with requesting device 110₁, and sends to requesting device 110₁ the status structure associated with queue 316₁. After sending the status structure, servicing program 312 terminates the connection. Alternatively, servicing program 312 may keep the connection open to process, for example, other Read Status Structure commands.

While it has been illustrated and described what are at present considered to be preferred embodiments and methods of the present invention, it will be understood by those skilled in the art that various changes and modifications may be made, and equivalents may be substituted for elements thereof without departing from the true scope of the invention.

In addition, many modifications may be made to adapt a particular element, technique or implementation to the teachings of the present invention without departing from the central scope of the invention. Therefore, it is intended that this invention not be limited to the particular embodiments and methods disclosed herein, but that the invention include all embodiments falling within the scope of the appended claims.

1. A method for performing services in a multimedia network including a first device and a second device, said method comprising the steps of:
receiving, at the second device, a first request from the first device via a serial interface;
storing the received first request in a queue at the second device; and
retrieving from the first device data associated with the stored first request when the first device provides the data and the second device performs a service associated with the stored first request.

2. The method of claim 1, further comprising the step of:
notifying, at the first device, a third device in the multimedia network as to the stored first request, the data, and the second device when the third device provides the data.

3. The method of claim 1, further comprising the step of:
retrieving the data from a third device in the multimedia network when the third device provides the data and the second device performs the service associated with the stored first request.

4. The method of claim 1, further comprising the step of:
performing a service associated with a second request stored in the queue when the stored first request is in the queue.

5. The method of claim 1, further comprising the step of:
sending one or more results associated with the performed service to the first device when the stored first request identifies the first device for receiving the results.

6. The method of claim 1, further comprising the step of:
sending one or more results associated with the performed service to a third device in the multimedia network when the stored first request identifies the third device for receiving the data.

7. The method of claim 1, further comprising the step of:
removing the stored first request from the queue after the second device performs the service associated with the stored first request.

8. The method of claim 1, further comprising the step of:
determining, at the first device, the status of requests in the queue.

9. The method of claim 1, further comprising the step of:
modifying the priority of the stored first request.

10. The method of claim 1, further comprising the step of:
modifying the order of requests in the queue.

11. The method of claim 1, wherein the receiving step comprises the step of:
receiving the first request from the first device via a high speed serial interface.

12. The method of claim 1, wherein the receiving step comprises the step of:
receiving the first request from the first device via an IEEE 1394 interface.

13. The method of claim 1, wherein the receiving step comprises the step of:
receiving the first request from the first device via a low speed serial interface.

14. The method of claim 1, wherein the retrieving step comprises the steps of:
establishing, at the first device, a connection between the first device and the second device; and
sending the data on the established connection to the second device.

15. A method for performing services in a multimedia network including a first device and a second device including a plurality of queues, said method comprising the steps of:
receiving, at the second device, a first request from the first device via a serial interface;
selecting one of the plurality of queues;
storing the received first request in the selected queue; and
retrieving from the first device data associated with the stored first request when the first device provides the data and the second device performs a service associated with the stored first request.

16. The method of claim 15, further comprising the step of:
notifying, at the first device, a third device in the multimedia network as to the stored first request, the data, and the second device when the third device provides the data.

17. The method of claim 15, further comprising the step of:
retrieving from a third device in the multimedia network the data associated with the stored first request when the third device provides the data and the second device performs the service associated with the stored first request.

18. The method of claim 15, further comprising the step of:
performing a service associated with a second request in the queue when the stored first request is in the selected queue.

19. The method of claim 15, further comprising the step of:
removing the stored first request from the selected queue after the second device performs the service associated with the stored first request.

20. The method of claim 15, wherein the receiving step comprises the step of:
receiving the first request from the first device via a high speed serial interface.

21. The method of claim 15, wherein the receiving step comprises the step of:
receiving the first request from the first device via an IEEE 1394 interface.

22. The method of claim 15, wherein the receiving step comprises the step of:
receiving the first request from the first device via a low speed serial interface.

23. A method for performing services in a multimedia network including requesting devices and servicing devices, said method comprising the steps of:
receiving, at the servicing devices, requests from a first set of the requesting devices, respectively, via serial interfaces;
storing the received requests in queues at the servicing devices; and
retrieving from the first set of requesting devices data associated with the stored requests when the first set of requesting devices provide the data and the servicing devices perform services associated with the stored requests.

24. The method of claim 23, further comprising the step of:
notifying, at the first set of requesting devices, a second set of devices in the multimedia network as to the stored requests, the data, and the servicing devices when the second set of devices provide the data.

25. The method of claim 23, further comprising the step of:
retrieving from a second set of devices data associated with the stored requests when the second set of devices provide the data and the servicing devices perform the services associated with the stored requests.

26. An apparatus for use in a multimedia network including a first device and a second device, said apparatus comprising:
a servicing program for receiving a request from the first device via a serial interface, and for storing the received request in a queue, and for retrieving from the first device data associated with the stored request when performing a service associated with the stored request and the first device provides the data, and for retrieving from the second device the data when performing the service and the second device provides the data; and
a processor for executing the servicing program.

27. The apparatus of claim 26, wherein the serial interface is a high speed serial interface.

28. The apparatus of claim 26, wherein the serial interface is an IEEE 1394 interface.

29. The apparatus of claim 26, wherein the serial interface is a low speed serial interface.

30. A system for use in a multimedia network including a plurality of devices, said system comprising:
a requesting program for sending a request to one device via a serial interface, and for sending data associated with the request to the one device when the system provides the data and the one device requests the data, and for notifying another device as to the request, the data, and the one device when the other device provides the data; and
a processor for executing the requesting program.

31. The system of claim 30, wherein the serial interface is a high speed serial interface.

32. The system of claim 30, wherein the serial interface is an IEEE 1394 interface.

33. The system of claim 30, wherein the serial interface is a low speed serial interface.

34. A computer-readable medium capable of configuring a computer to perform a method for performing services in a multimedia network including a first device, a second device, and a third device, said method comprising the steps of:
receiving, at the second device, a first request from the first device via a serial interface;
storing the received first request in a queue at the second device;
retrieving from the first device data associated with the stored first request when performing a service associated with the stored first request and the first device provides the data; and
retrieving from the third device the data when performing the service and the third device provides the data.
